(19) United States
(12) Patent Application Publication
(10) Pub. No.: US 2024/0014728 A1
(43) Pub. Date: Jan. 11, 2024

(54) BIDIRECTIONAL BUCK-BOOST CONTROLLER

(71) Applicant: Derek Simkowiak, Lynnwood, WA (US)

(72) Inventor: Derek Simkowiak, Lynnwood, WA (US)

(73) Assignee: Holding Zero, LLC, Albuquerque, NM (US)

(21) Appl. No.: 18/349,767

(22) Filed: Jul. 10, 2023

Related U.S. Application Data
(60) Provisional application No. 63/359,254, filed on Jul. 8, 2022.

(51) Int. Cl. H02M 1/088; H02M 3/158

(52) U.S. Cl. CPC H02M 1/088; H02M 3/1582

(57) ABSTRACT

The bidirectional synchronous soft-switching DC-to-DC buck-boost controller of the present disclosure comprises a means for controlling electronic switches for synchronous voltage rectification on both electrical sides of the regulator (the high-voltage side and the low-voltage side). This allows the controller to use carefully-timed switches, in conjunction with other circuit components such as inductors and capacitors, to regulate energy flow. The controller also contains a means for sensing voltage on both of said sides. This allows the controller to determine the optimal switching rate for a given operating mode via an algorithm. The algorithm is executed electronically using a means such as, but not limited to, a central processing unit (CPU), an application-specific integrated circuit (ASIC), a field-programmable gate array (FPGA), or a parallel processor.

### CROSS-REFERENCE TO RELATED APPLICATIONS

This application claims the benefit of U.S. Provisional Patent Application Ser. No. 63/359,254 filed Jul. 8, 2022, titled “BIDIRECTIONAL BUCK-BOOST CONTROLLER,” and the subject matter thereof is incorporated herein by reference thereto.

### TECHNICAL FIELD

The present disclosure relates to a novel bidirectional buck-boost controller for use in direct current (DC) DC-to-DC voltage conversion. More particularly, the present disclosure relates to structural, electrical, and operational aspects of the bidirectional buck-boost controller.

### BACKGROUND ART

Modern technology devices which utilize electricity must manage energy flow. This is done by various electrical circuits and components, including voltage regulators, as would be known to a person having ordinary skill in the art. Said voltage regulators include, but are not limited to, components such as linear regulators, low-dropout regulators (LDOs), and buck-boost regulators.

Of the buck-boost regulators, a switching controller is a well-known component. The controller can be connected in a variety of circuit configurations. Depending on the features of the circuit, the controller can be bidirectional (allowing energy flow in both directions), synchronous (which utilizes switches instead of Schottky diodes), and soft-switching (which uses careful switch timing to improve efficiency).

The present disclosure provides a novel bidirectional synchronous soft-switching DC-to-DC buck-boost controller that has an output voltage magnitude that is either greater than or less than the input voltage magnitude. The controller of the present disclosure can be used in any application where a DC voltage level conversion is necessary, including, but not limited to, management of battery charging or discharging, mobile technologies, energy harvesting, power optimization, or power management integrated circuit (PMIC) applications.

None of the prior art fully addresses the problems resolved by the present invention. The present invention overcomes these limitations contained in the prior art.

Certain embodiments of the invention have other steps or elements in addition to or in place of those mentioned above. The steps or element will become apparent to those skilled in the art from a reading of the following detailed description when taken with reference to the accompanying figures, if any.

### BRIEF DESCRIPTION OF THE SEVERAL VIEWS OF THE DRAWINGS

FIG. 1 illustrates a top-down view of the bidirectional buck-boost controller, according to certain embodiments of the invention.

FIG. 2 illustrates a method of operating the bidirectional buck-boost controller, according to certain embodiments of the invention.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system, if any, are semi-diagrammatic and not to scale and, particularly, some of the dimensions are for the clarity of presentation and are shown exaggerated in the drawing figures.

Alternate embodiments have been included throughout, and the order of such are not intended to have any other significance or provide limitations for the present invention.

For expository purposes, the term “horizontal” as used herein is defined as a plane parallel to the plane or surface of the present apparatus, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane, as shown in the figures, if any. The term “on” means that there is direct contact among elements.

The words “including”, “comprising”, “incorporating”, “consisting of”, “have”, and “is” are meant to be non-exclusive, meaning additional items, components or elements may be present. Joinder references such as “connected”, “connecting”, and “coupled” do not limit the position, orientation, or use of systems and/or methods, and do not necessarily infer that two elements are directly connected. All identifying numerical terms are for identification only, and do not refer to the order or preference of any element, embodiment, variation and/or modification.

The present disclosure provides a bidirectional synchronous soft-switching DC-to-DC buck-boost controller comprising a means for controlling one or more high-voltage side switches for synchronous rectification; a means for controlling one or more low-voltage side switches for synchronous rectification; a means for sensing voltage on the high-voltage side; a means for sensing voltage on the low-voltage side; a means for executing an algorithm; an algorithm to determine an optimized switching rate for a given operating mode; a means to vary the switching rate to any value within a predefined range, in real time; and a means for varying the operating mode.

The bidirectional synchronous soft-switching DC-to-DC buck-boost controller of the present invention further comprising: wherein the means of controlling a switch on either the high voltage side or the low voltage side comprises a voltage signal connected to a pulse-width modulation timer; wherein the means of sensing a voltage on either the high voltage side or the low voltage side comprises an analog-to-digital converter connected to a voltage sensor circuit; a means for sensing temperature; wherein the means of sensing temperature is an analog-to-digital converter connected to a temperature sensor circuit; wherein the temperature sensor circuit comprises a thermistor; a means for sensing electrical current on any of the high voltage side and/or the low voltage side; wherein the means of sensing electrical current comprises an analog-to-digital converter connected to a current sensor circuit; wherein the various means are comprised of discrete electrical components; wherein the various means are contiguous within an integrated circuit; electrical switches for synchronous rectification; wherein the electrical switches are metal-oxide-semiconductor field-effect transistors (MOSFETs); wherein the various means are comprised of discrete electrical components; wherein the various means are contiguous within an integrated circuit; a means for power path control such that the high side can be electrically disconnected from the low side; wherein the means for power path control is a MOSFET; one or more data buses, including, but not limited to, an Inter-Integrated Circuit (IIC) compatible data bus; a means to communicate values including, but not limited to, voltage, amperage, and temperature, using the data buses; wherein the algorithm uses temperature information to determine the switching rate.

The present disclosure further provides a method of operating a buck-boost controller, the method comprising sending a signal to indicate operating mode; optionally, also sending parameters for use in an algorithm; reading external inputs, such as voltage, amperage, and temperature; computing an algorithm to determine buck-boost switching rate based on input parameters; and controlling one or more switches for synchronous rectification.

The present disclosure provides a bidirectional synchronous soft-switching DC-to-DC buck-boost controller that comprises a means for controlling electronic switches for synchronous voltage rectification on both electrical sides of the regulator (the high-voltage side and the low-voltage side). This allows the controller to use timed switches, in conjunction with other circuit components such as inductors and capacitors, to regulate energy flow.

The controller of the present disclosure also comprises a means for sensing voltage on both of said sides. This allows the controller to determine the optimal switching rate for a given operating mode via an algorithm. The algorithm is executed electronically using a means such as, but not limited to, a central processing unit (CPU), an application-specific integrated circuit (ASIC), a field-programmable gate array (FPGA), or a parallel processor.

The switching rate of the controller of the present disclosure is not limited to a fixed set of predefined values, but instead can be an optimal rate within a predefined range. The algorithm can adjust the switching rate in real time, or halt energy transfer altogether, depending on the current operating mode.

The controller of the present disclosure supports one or more operating modes. For example, battery-related applications may include charge-under-load mode, ship mode, standby mode, over/under voltage protection mode, and other modes of operation. The algorithm uses the operating mode to determine the current switching rate, thus controlling the flow of energy. The operating mode selection method includes, but is not limited to, static configuration (such as a resistor value or digital signal), a software configuration, or by an external input via a communication bus.

Details to specific aspects or features of the present inventions are described below. Certain examples are illustrated in the accompanying drawings. Corresponding reference numbers will be used throughout the drawings to refer to the same or corresponding parts.

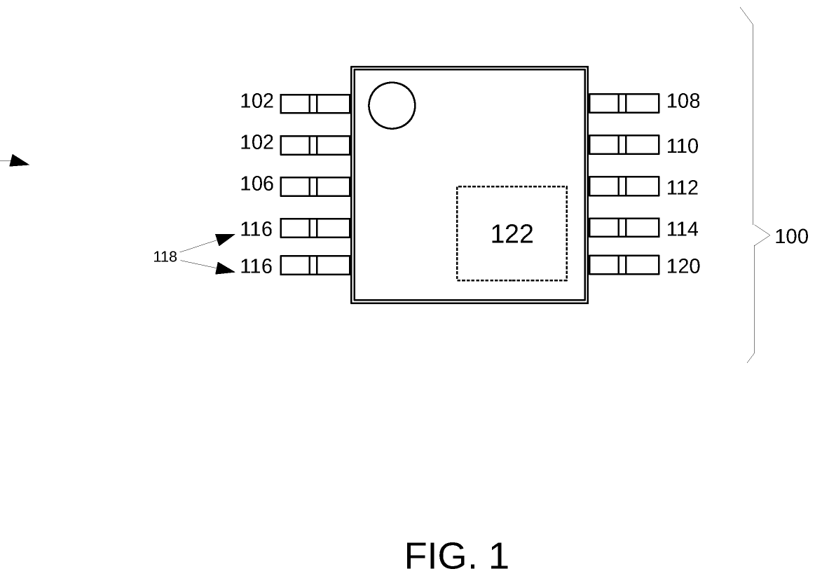

FIG. 1 illustrates a top view of the bidirectional buck-boost controller 100, according to certain embodiments of the invention. There are two pulse-width modulation timers which control switches 102, which are used synchronously to control energy flow. An analog-to-digital converter (ADC) connected to a temperature sensor circuit 106 allows temperature to be used as an input to the algorithm, which is executed on CPU 122, and which may be reported via communication bus 116. ADCs connected to a voltage sensor circuit allow for sensing voltage on both the high side 108 and low side 110 of said controller, such that said voltages may be reported via the communication bus 118, and also used as an input to said algorithm. Separately, ADCs connected to a current sensor circuit on the high side 112 and low side 114 measure current, which may be reported via the communication bus 118, and also integrated over time such that energy flow can be optimized for the current operating mode. The controller 100 has a ground connector 120 for operation in an electrical circuit.

In certain embodiments, there maybe be one or more pulse-width modulation timers which control switches 102 to support operating modes including, but not limited to, half-bridge and full-bridge modes.

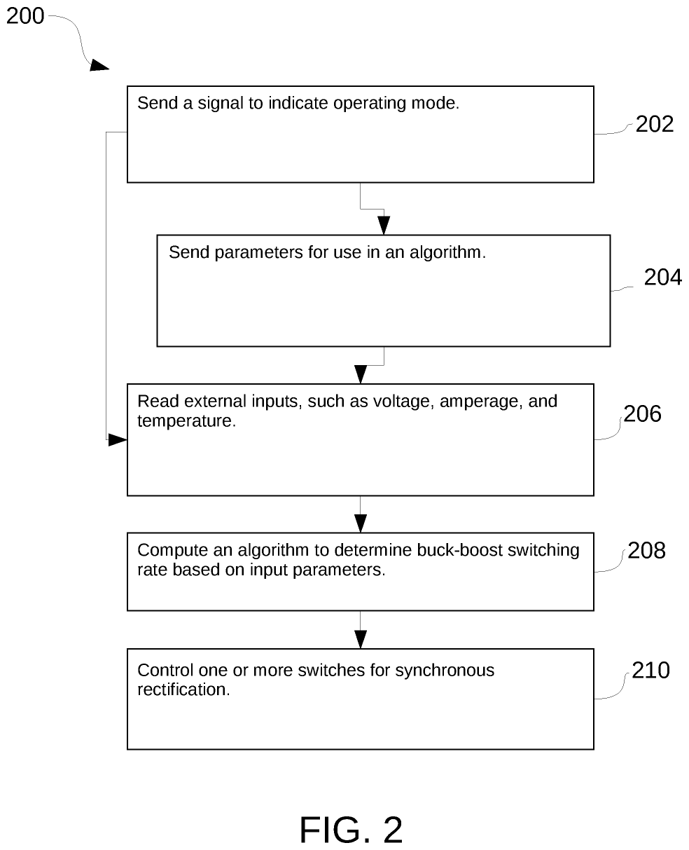

FIG. 2 illustrates a method 200 of operating a buck-boost controller, according to certain embodiments. According to method 200, at step 202 a signal is sent to indicate operating mode. Optionally, at step 204 additional input parameters may be input to said algorithm. Step 206 reads external inputs, such as voltage, amperage, and temperature, as inputs for said algorithm. Step 208 computes an algorithm to determine buck-boost switching rate based on input parameters. Step 210 controls one or more switches for synchronous rectification.

In certain embodiments, step 206 may be omitted, and the algorithm may determine said buck-boost switching rate directly.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying figures are to be interpreted in an illustrative and non-limiting sense.

### LIST OF ELEMENTS SHOWN ON THE DRAWINGS

100 Bidirectional buck-boost controller
102 Pulse-width modulation timer connected to a switch
106 Analog-to-digital converter connected to a temperature sensor circuit
108 Analog-to-digital converter connected to a high-side voltage sensor circuit
110 Analog-to-digital converter connected to a low-side voltage sensor circuit
112 Analog-to-digital converter connected to a high-side current sensor circuit
114 Analog-to-digital converter connected to a low-side current sensor circuit
116 Communication bus connector
118 Communication bus
120 Ground connector
122 Central processing unit
200 Method
202 Step
204 Step
206 Step
208 Step
210 Step

1. A bidirectional synchronous soft-switching DC-to-DC buck-boost controller comprising:
a means for controlling one or more high-voltage side switches for synchronous rectification;
a means for controlling one or more low-voltage side switches for synchronous rectification;
a means for sensing voltage on the high-voltage side;
a means for sensing voltage on the low-voltage side;
a means for executing an algorithm;
an algorithm to determine an optimized switching rate for a given operating mode;
a means to vary the switching rate to any value within a predefined range, in real time; and
a means for varying the operating mode.

2. The buck-boost controller of claim 1, wherein the means of controlling a switch on either the high voltage side or the low voltage side comprises a voltage signal connected to a pulse-width modulation timer.

3. The buck-boost controller of claim 1, wherein the means of sensing a voltage on either the high voltage side or the low voltage side comprises an analog-to-digital converter connected to a voltage sensor circuit.

4. The buck-boost controller of claim 1, further comprising a means for sensing temperature.

5. The buck-boost controller of claim 4, wherein the means of sensing temperature is an analog-to-digital converter connected to a temperature sensor circuit.

6. The buck-boost controller of claim 5, wherein the temperature sensor circuit comprises a thermistor.

7. The buck-boost controller of claim 1, further comprising a means for sensing electrical current on any of the high voltage side and/or the low voltage side.

8. The buck-boost controller of claim 7, wherein the means of sensing electrical current comprises an analog-to-digital converter connected to a current sensor circuit.

9. The buck-boost controller of claim 1, wherein the various means are comprised of discrete electrical components.

10. The buck-boost controller of claim 1, wherein the various means are contiguous within an integrated circuit.

11. The buck-boost controller of claim 1, further comprising electrical switches for synchronous rectification.

12. The buck-boost controller of claim 11, wherein the electrical switches are metal-oxide-semiconductor field-effect transistors (MOSFETs).

13. The buck-boost controller of claim 11, wherein the various means are comprised of discrete electrical components.

14. The buck-boost controller of claim 11, wherein the various means are contiguous within an integrated circuit.

15. The buck-boost controller of claim 1, further comprising a means for power path control such that the high side can be electrically disconnected from the low side.

16. The buck-boost controller of claim 15, wherein the means for power path control is a MOSFET.

17. The buck-boost controller of claim 1, further comprising one or more data buses, including, but not limited to, an Inter-Integrated Circuit (IIC) compatible data bus.

18. The buck-boost controller of claim 17, further comprising a means to communicate values including, but not limited to, voltage, amperage, and temperature, using the data buses.

19. The buck-boost controller of claim 1, wherein the algorithm uses temperature information to determine the switching rate.

20. A method of operating a buck-boost controller, the method comprising:
sending a signal to indicate operating mode;
optionally, also sending parameters for use in an algorithm;
reading external inputs, such as voltage, amperage, and temperature;
computing an algorithm to determine buck-boost switching rate based on input parameters; and
controlling one or more switches for synchronous rectification.
